(19) United States
(12) Patent Application Publication
(10) Pub. No.: US 2020/0187434 A1
(43) Pub. Date: Jun. 18, 2020

(54) Drip and Bubbler Irrigation Releasing Device and Method

(71) Applicant: Paul Anthony Roide, Palm Springs, CA (US)

(72) Inventor: Paul Anthony Roide, Palm Springs, CA (US)

(21) Appl. No.: 16/221,779

(22) Filed: Dec. 17, 2018

(51) Int. Cl. A01G 25/02; A01G 29/00; A01N 25/08

(52) U.S. Cl. CPC A01G 25/023; A01N 25/08; A01G 29/00

(57) ABSTRACT

A drip or bubbler irrigation system releasing device consisting of a chemical bond between a fertilizer, herbicide, insecticide or other desired chemicals and a water soluble medium, forming a molded device of various shapes and sizes used in conjunction with drip or bubbler irrigation system water emitters, allowing for the slow dissolution of the chemicals of the release device over a time period of weeks or months, so that on each irrigation cycle the water soluble chemicals are released to the planted areas below and around the emitter in a slow continuous manner.

### BACKGROUND OF INVENTION

### 1. Field of Invention

The present invention relates to the field of irrigation systems designed to conserve water, such as low volume drip irrigation emitters, bubblers, micro bubblers and any other watering type emitter whose output is limited in volume and is concentrated in a small circumference around itself. It details a design and method of manufacture for a device that will attach under a drip emitter or drip bubbler and that uses the gravity flow of the water leaving the emitter to slowly dissolve and release chemicals within the water soluble device underneath it during the irrigation cycle. More specific, the present invention relates to a method and system for attaching a fertilizing device to a standard drip irrigation emitter providing a low cost, replaceable, and controllable fertilizer delivery each time the emitter releases water in the watering cycle of the drip irrigation system. In another embodiment of this design, the present invention relates to a method and system for attaching a fertilizing device underneath a standard bubbler irrigation device or underneath any number of micro bubblers and micro sprinkler devices, which in the same manner provide fertilizer each time the emitting device releases water in the watering cycle of the drip irrigation system. The primary anticipated use of the irrigation releasing device will be in the delivery of fertilizing nutrients. However other practical applications include delivery of plant insecticides to deter those insects most likely to feed on the plant and delivery of plant herbicides that will counter grass or weeds growing around the plant. In practice a grower may use all three devices simultaneously as they can all release their chemical additives when exposed to irrigation flow at the emitter or bubbler without interfering with each other in a stacked array. The present invention details a device that attaches to a irrigation system emitter pipe or drip tube and a method of manufacture that will allow it to provide any number of chemicals combinations in a water soluble medium for slow release dissolution by water emitted during normal irrigation cycles. For simplicity sake, the following descriptions of prior art will focus on the device used as a fertilizing medium.

### 2. Description of Prior Art

Fertilizer delivery systems are generally found within two categories, waterborne systems or dry application systems. Waterborne systems are used to feed water based fertilizers in-line to an existing irrigation system. They must be plumbed into the irrigation system and remain a permanent part of the system, and must be maintained as a function of the watering rate. Waterborne systems offer the advantages of instant and concentrated fertilizing, but are expensive and difficult to use in a manner that allows for gradual, long term continuous feeding within the irrigation system. Water fertilizing systems have holding tanks of premixed fertilizer which can only be so large, so they use concentrated amounts that are dispersed fully within one or more watering cycles. They must be re-filled for the next fertilizing cycle, usually within days or weeks. Complex timing controls are needed on the injecting fertilizing unit to time the controlled release of fertilizers, further adding to the cost and complexity of the system. Therefore, most water borne fertilizer distribution is a very expensive and complicated process and is used mainly on large sprinkler type applications such as parks and golf courses or in large commercial nursery environments.

Dry application fertilizing systems are used outside the water delivery system. Most of them contain chemicals pellets that are coated with a resin designed to break down when exposed to the micro bacteria in soil. They are designed to slowly release their nutrients over time but must be physically spread over the surface of the desired fertilized area such as around a plant or landscape surface and must be buried beneath the soil and wetted during the watering process to achieve a nutrient release. This small pellets are often spread by a seed spreader machine that rotates the fertilizing pellets in a drum while throwing them out in a circular pattern so that it can be easily applied to a large area by walking in circles around the area to be fertilized. This is commonly done on home lawns and small area landscaping. Larger, farm type systems use automated machinery that dispense the fertilizing pellets directly into the soil as the equipment turns the soil in the field or plants the seeds during initial stages of the planting cycle.

Dry fertilizing applicators suffer the physical problems of positioning the pellets or powder widely and evenly around the target plants, while avoiding the effects of wind, rain, and runoff and of physical displacement from workers, animals or machinery to stay in the target area and deliver its nutrients. They must also be buried enough to be in contact with the soil and have access to a water source that will cover them fully and dissolve them at a slow, steady rate so they can be absorbed into the soil and used by a plant over consistent, long periods of time. Most of the dry fertilizers are used with sprinkler type irrigation systems over large areas where high pressure and a high volumes of water are needed to dissolve the fertilizing material. Typical pellet type fertilizers can last from three to four months depending on the watering cycles they receive. Over time and exposure to water and air they lose some of their fertilizing potency, especially if they are unable to dry out between watering cycles. Over wetting of the pellet type fertilizer causes it to dissolve and be applied too rapidly to the soil causing irregular and short term nutrient delivery. This is another problem in many dry fertilizer irrigation delivery systems, one that need to be watched carefully. One can sometimes see burn marks on lawns when the fertilizing pellets (or powders) are absorbed too rapidly over a short time. None of the dry fertilizing systems now in use were designed for low volume, water efficient drip irrigation systems which typically require liquid fertilizing systems if they fertilized at all. Liquid fertilizing systems present a particular problem to drip irrigation systems because the dissolved solids of the fertilizers tend to clog the emitter ports. A typical drip emitter is designed with millimeter tolerances to limit flow from high pressure sources and should not be subjected to any liquids having chemicals. Even normal tap water having high mineral (hard water) content tends to clog emitters making their replacement more regular and adding expense to the irrigation maintenance program.

Accordingly, there exists a need to provide a fertilizing distribution system which is simple to use and is effective with low volume drip type emitter irrigation systems and other low volume or medium volume emitters such as bubblers and micro bubblers. This system should spread the fertilizing medium evenly and gradually in a targeted area over long periods of time, in-line with the water delivery source but not inside it. The system should be easily installed and replaced, be of low cost, and be able to be designed to match the specific fertilizing needs (or other needs) of a given plant or landscape by simply varying the formula contained within it.

In the research for wet fertilizer applicators, Schmidt, U.S. Pat. No. 5,252,302 introduces and liquid fertilizer apparatus that employs an internal cavity that receives a porous bag member having fertilizer contained therein and attaching to a water supply source such as a hose bib. This invention does not lend itself to modern irrigation systems much less a drip or bubbler irrigation system it shows no delivery system for the pouch to the desired planted areas and because of the chemicals it releases, if connected to a drip irrigation system will clog the emitters down line of the input pouch. The present invention provides a means for a molded device to attach to each individual emitter and whose chemical content can be varied for each individual plant as opposed to a one position (at water input) fertilizing system that also requires maintenance in the refill the porous container. Strong, U.S. Pat. No. 5,005,601 discloses a waterborne delivery system employing one air tank and one tank of fertilizing solution to be injected into an irrigation system. Irrigation water is allowed to fill the air tank where the remaining compressed air is allowed to pass through the top of the fertilizing container forcing the fertilizing solution from the bottom of the container into the irrigation system. Davis, U.S. Pat. No. 6,173,732 discloses a system whereby liquid fertilizer is mixed with irrigation water in a mixing chamber attached to the valve of an existing sprinkler system. Adler, U.S. Pat. No. 4,859,157 discloses a device that injects liquid fertilizer into an irrigation pipeline by means of an axial turbine impeller. Similarly, Johnson, U.S. Pat. No. 6,997,350 relates a system for adding liquid fertilizer into a sprinkler system by means of a mechanical injector comprising a paddle wheel within the water line. Astle, U.S. Pat. No. 5,383,601 describes a liquid fertilizer for a drip irrigation system wherein a reservoir holding the liquid fertilizer is held and controlled by means of inlet and outlet valves.

Other liquid fertilizing applicator systems include Terrell, U.S. Pat. No. 4,768,712, Agius, U.S. Pat. No. 4,456,176 Roberts, U.S. Pat. No. 7,093,606, Jester U.S. Pat. No. 5,836,518 and Francis, U.S. Pat. No. 6,267,303. Each of these systems relies on liquid fertilizers that are in some way injected into an irrigation supply line. Water based injector type fertilizer systems are most effectively used with higher volume irrigation systems like sprinklers where large areas of plants or landscape are watered and fertilized at one time. These systems are not suited well to low volume, high efficiency systems like drip irrigation because they tend to clog the drip elements and are not effectively absorbed into the soil in small areas due to the concentration of fertilizer content.

In reviewing the prior art of dry fertilizer applicators used with drip irrigation systems, only one specific reference was found of devices to be used with drip irrigation emitters. Greubel, U.S. Pat. No. 5,769,318, discloses a plastic housing encompassing a drip emitter and a chamber where a chemical fertilizer tablet, surrounded by a plastic jacket with holes is positioned downstream of the emitter. When water flows from the emitter within the housing, it flows through holes within the jacket and through the tablet, absorbing fertilizing chemicals and flowing outward through holes in the end of the housing. This system is ineffective in use because using a tablet in this manner will impede the natural flow of the drip emitter until it is somewhat dissolved, as the tablet itself contains no holes, only the surrounding jacket. Unless the tablet is very porous in nature water will not easily flow through it until it has dissolved to some degree and it would seem to present a problem as it softened and clogged the housing. The tablet inside such a housing would not receive enough air between watering to allow the fertilizing chemicals to dry out and therefore the tablet would become soft and disperse fertilizer too rapidly if soft or not rapid enough (or at all) if clogged within the enclosure. In addition, having the fertilizing tablet before the emitter and in the same hosing as the emitter would allow for backflow of chemicals into the emitter clogging the delicate and microscopic emitter plunger with dissolved solids and keeping it either permanently closed shut or wide open, as does even high PH (hard or calcified) supply water over time. It would also seem to be complex to manufacture and difficult to keep dirt and foreign materials from entering the drain holes, another potential source of water stoppage. Finally, it is difficult to use in the field since there is no way to tell when the tablet has dissolved and the device needs to be replaced. The present invention described below overcomes these design flaws and delivers a device that works independent of and with any external drip emitter as well as with other low volume emitters like bubblers and variable flow emitters now common to the irrigation industry. It creates no chemical backflow that can cause emitter damage while fully draining after each watering for long chemical life and low waste. In addition, its fertilizing source can be visually checked for content during maintenance and easily changed when needed. In the research of current patents there is none that provide the clear advantages and usefulness of the present invention.

### SUMMARY OF INVENTION

The present invention provides a low cost and effective means to introduce fertilizers and other chemicals into a drip irrigation system by simply placing a water soluble molded device underneath the drip emitter or bubbler where it stays and place and slowly dissolves with each watering cycle with water for optimum penetration into the plant's root system and surrounding soil. The invention involves three distinct embodiments. In the preferred embodiment (FIG. 1) the fertilizer and binding element are molded into a flexible, semi rigid shape that allows it to fit over the bubbler device or drip emitter and be adjusted in position for optimum exposure to downward flowing emitter water. In another embodiment where the molded fertilizing mixture is solid in form the mold will contain a spring clip surrounding the internal circumference of the device allowing it to secure to a bubbler or drip device by means of spring tension between the device and the emitter or attaching pipe (FIG. 2). In another embodiment, the invention can be molded into in a long strip which is then cut into specific sizes designed to fit around a drip or bubbler flow emitter by means of a water proof self adhesive tape or glue backing. The strips can be applied in a tape like fashion by removing the backing and wrapping it around the emitter device or attaching tube/pipe (FIG. 6). Yet another embodiment would be to have the bonded fertilizer material be inserted into a porous nylon bag that would then fit over the emitter or bubbled head and clip in place (FIG. 7) by means of a wire or plastic strip twisted together securing it to the drip tube under the emitter (14). Each of these embodiments accomplish the same end goal, that of securing a water soluble chemical medium underneath a drip or bubble emitter so that it will slow dissolve and release nutrients to the plant on every watering cycle. Of course there are perhaps hundreds of different embodiments of design and manufacture but the present invention reserves the right to the idea of adding a water soluble medium in any particular shape or chemical composition to a drip or bubbler emitter irrigation device secured in place underneath the emitter output so that the molded medium will slowly dissolve over time upon each watering cycle. The present invention is not limited to just fertilizing as the same techniques can be used to deliver other chemicals such as insecticides, herbicides and any other materials beneficial to plant growth and care The water, as it flows over the soluble material releases the chemicals therein which falls to the ground and is absorbed by the soil around the plant. Soon after the drip cycle ends, the medium, being open to air that surrounds it, is able to aerate and dry, preserving itself for the next watering cycle. The medium is made to last for a 3-12 month period, depending on the design of the device and percentage content of release medium, and can be easily checked by visual observation as to the need for replacement. It can be replaced easily and effectively allowing for use of different fertilizers/insecticides/herbicides for specific plants and growing seasons. Since each embodiment of the design is placed below the water output of the drip or bubbler device there is no chance of chemical backflow from entering the water supply system and the emitters stay dry and free of chemical debris.

The present invention thus provides a very cost effective way for growers and landscapers to fertilize with very low associated maintenance. It allows for easy installation, easy status checking and easy replacement and can be made to any chemical specification desired by the grower. For example, the grower may specify a certain fertilizing formula during early plant growth and be able to vary that formula by replacing the device as the plant matures or as it blossoms and needs others nutrients. Or the grower may add another device that releases a herbicide during the season when insects are most active protecting the plant in place without need for further spraying or control. The devices are cost effective, easily to install and change and do not degrade over time.

There are several ways to manufacture the present invention. One method involves mixing the desired medium with a type of chemical starch and adding water. The mixture is then poured into a mold heated and dried. Other products can be added to the mixture for color, stability, flexibility and to slow or accelerate the dissolution rate of the product. The resulting product is flexible, water soluble and can be formed into the various shapes and sizes indicated by the drawings. Another method involves using micro-wax additives that are water insoluble and when heated will attach to the desired medium and stay attached, protecting it from water and allowing for a slow dissolution of the medium. The micro-waxes are thoroughly mixed with the medium and other products are added for color, flexibility, stability and dissolution rate control. The mixture is then poured into molds and heated. The resulting product is again flexible, water semi-soluble and can be formed into the various shapes and sizes indicated by the drawings. Yet another method of manufacture involves using water soluble polymers that are mixed with other additives for color, flexibility, stability and dissolution rate control and are heated together at various temperatures until liquid and then extruded or injected molded into various shapes suitable for same use. The resulting product is again flexible, water semi-soluble and can be formed into the various shapes and sizes indicated by the drawings.

Although the present invention has been described in its preferred forms with a certain degree of particularity, it is to be understood that the present disclosure has been made by way of example only. Numerous changes in the details of the compositions and ingredients therein as well as the methods of manufacture and design will be apparent to those skilled in the art without departing from the spirit and scope of the invention.

### BRIEF DESCRIPTION OF THE DRAWINGS

FIG. 1 is embodiment one of the invention showing a molded or cast chemical compound (2) with a hole (1) for receiving bubbler pipe or drip tube

FIG. 2 is embodiment one of the invention with added clip insert (3) for securing chemical compound to pipe or tube when needed

FIG. 3A is a side view of embodiment one with an adjustable bubbler emitter

FIG. 3B is a top view of embodiment one with an adjustable bubbler emitter

FIG. 4A is a side view of embodiment one with fixed flow drip emitter

FIG. 4B is a top view of embodiment one with fixed flow drip emitter

FIG. 5 is a side view of embodiment one with an adjustable drip emitter

FIG. 6 is a side view of embodiment two with an adjustable bubbler emitter

FIG. 7 is a side view of embodiment three with a fixed flow emitter

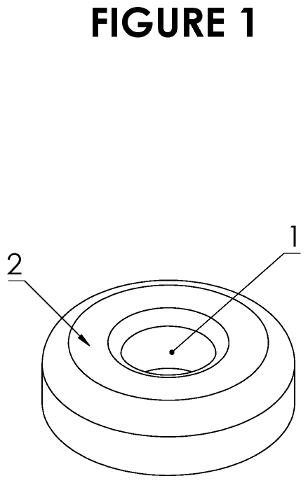

Each of the three preferred embodiments of the drip irrigation fertilizing system are shown in FIGS. 1 thru 7 and are comprised of the following components:

1. Insertion hole for Release Device fitting Water Supply Pipe or Drip Line Riser Tube
2. Release Device as a molded ring (Embodiment 1)

### 3. Release Device Optional Insertion Collar (Embodiment 1)

### 4. Adjustable Bubbler Emitter

### 5. Screw Head For Adjustable Emitter Flow Control

### 6. Water Supply Pipe/Drip Line Riser Tube

### 7. Water Flow Exiting out of Bubbler Emitter/Drip Emitter

### 8. Fixed Drip Emitter

### 9. Drip Emitter Nipple and Water Exit Port

### 10. Adjustable Drip Emitter

### 11. Screw Adjustment Threads For Adjustable Drip Emitter Flow Control

### 12. Release Device in a Flat Strip (Embodiment 2)

### 13. Release Device in a Porous Pouch (Embodiment 3)

### 14. Fastener of Porous Pouch to Drip Tube (Embodiment 3)

### 15. Spring Tensioned Panels of Insert Collar (Item 3) DETAILED DESCRIPTION OF DRAWINGS

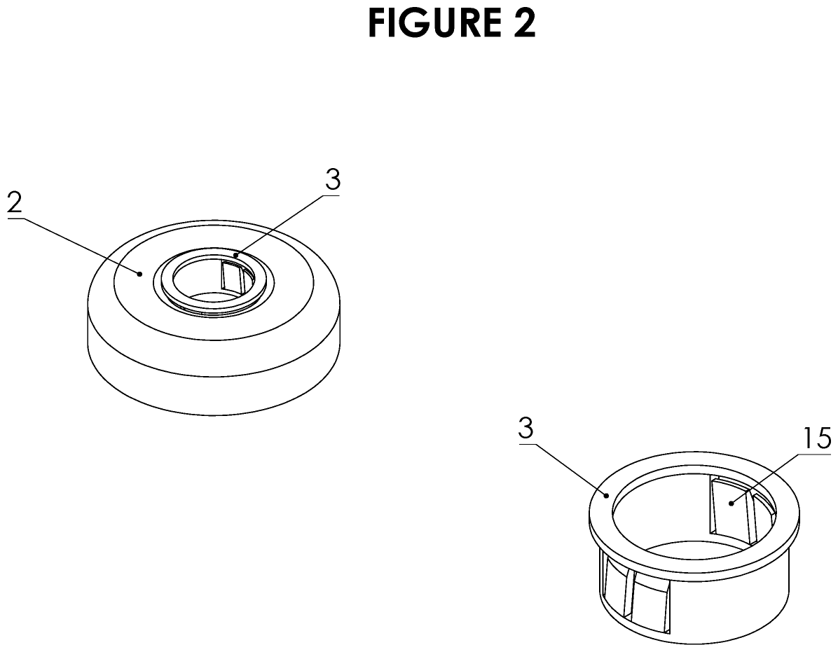

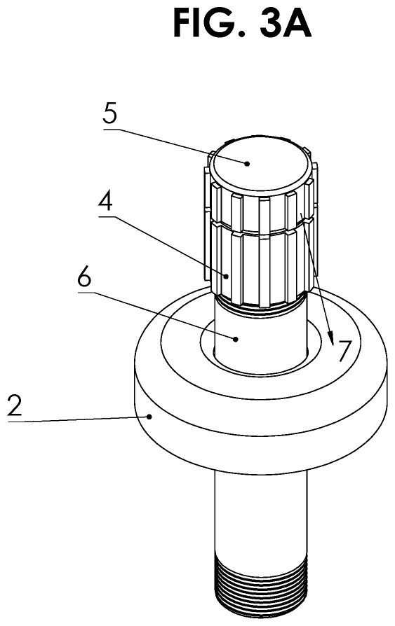

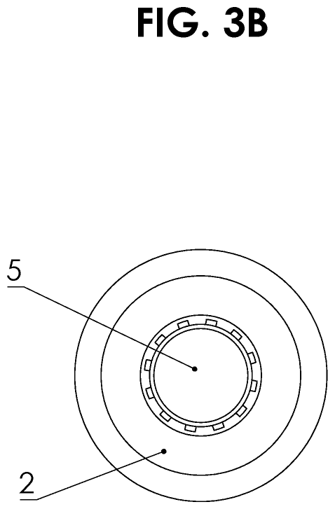

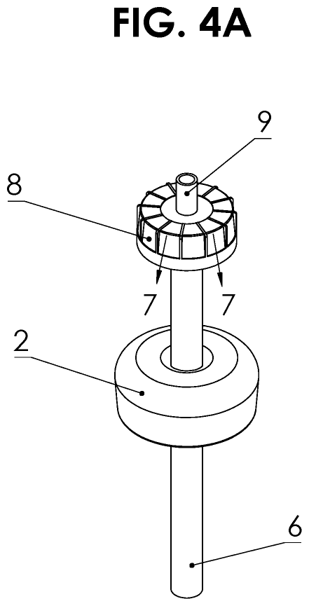

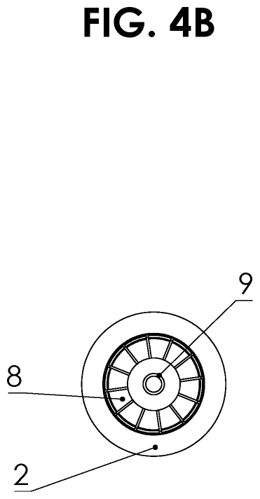

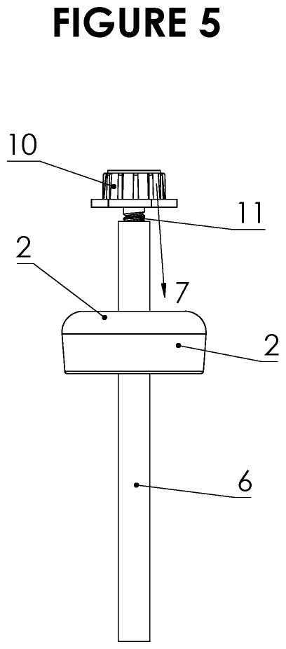

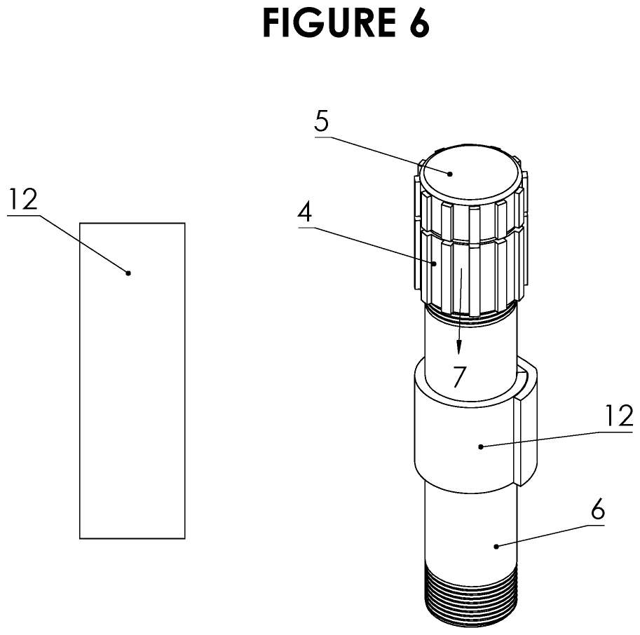

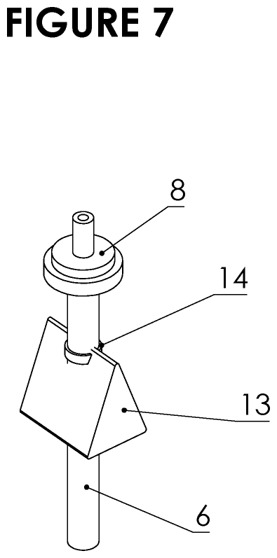

FIG. 1 shows the present invention in embodiment one where the releasing device containing the fertilizer, herbicide, insecticide or other desired formulas with the water soluble medium is molded into a round doughnut shape (2) with a hole (1) to receive a pipe or drip tube. FIG. 2 shows the same elements of FIG. 1 but adds an insert collar (3) that fits into the hole (1) of the doughnut shaped release device (2) and can be used to secure the device to the pipe of drip tube by means of spring tension. This insert device could be of molded plastic having small spring tensioned panels facing in both directions (15) to hold a rigid release device (which is harder in texture) to a pipe or drip tube (6) by spring tension on both sides. FIG. 3A shows a side view of the present invention in embodiment one where the release device (2) is placed underneath a bubbler emitter (4) and held by the attaching pipe (6). In this drawing and FIGS. 3B, 4A, 4B and 5, the device is flexible enough to adhere by surface tension to the pipe due to the chemical nature of the binding formula so the insertion device (3) as shown in FIG. 2 is not required to hold the device to the pipe (6). The flow from the bubbler emitter (4) indicated by arrows (7) is adjusted by a screw top (5) which is a common industry standard design. Other designs have this item (5) as a screw head on the top that is adjusted manually with a screw driver by the user. Both accomplish the same results and either emitter works equally well with the present invention. Water flows downward (7) from the bubbler over the chemical release device (2) releasing the water soluble chemicals of the device while falling downward thru gravitational pull to the planted areas on the ground below and around it. FIG. 3B shows a top view of FIG. 3A and is easily understood. FIG. 4A shows a side view of a fixed drip emitter (8) with the chemical release device (2) underneath secured to the drip tube (6) and exposed to water flow out of the nipple of the vertical emitter (9) where water flows (7) down and over the release device (2) releasing chemicals from the device while falling to the ground and absorbed into the planted areas below and around it. FIG. 4B shows a top view of FIG. 4A which is easily understood. FIG. 5 shows a drip emitter (10) that is adjustable by means of turning the emitter head via screw down threads (11) underneath it and attached to a vertical drip tube (6) with the release device (2) underneath and in the path of the water (7) flowing out of the emitter. Again as in FIG. 3A and FIG. 4A, the water flows over the water soluble release device and releases chemicals that flow downward into and around planted areas. FIG. 6 shows the present invention in embodiment two where the release device (12) is molded into a flat strip with an adhesive backing that is wrapped around the irrigation pipe (6). Again the emitter (4) releases water (7) that flows over the release device (12) and releases chemicals that flow downward into and around planted areas. FIG. 7 shows the present invention in third embodiment where the release chemicals are placed in a porous pouch (13) which is sealed and placed under the drip emitter (8). It is secured to the drip tube (6) by means of a wire or plastic wrap (14) and accomplishes the same results as the previous two embodiments.

What is claimed is:

1. A method of a providing a Drip or Bubbler irrigation system a chemical releasing system as an added device attached under emitters of said irrigation system, for long term, continuous application of either fertilizers, pesticides, herbicides or other desired chemical agents to provide water based chemical formulas to nearby growing areas in low cost, highly effective manner comprising the following steps:
A. Combining the desired fertilizer, pesticide, herbicide or other desired chemicals with a water soluble release agent,
B. Adding colorants or other chemicals to indicate the type of chemicals that are being released and their formulas and to provide a visual indication to the outside user as to when they should be replaced,
C. Adding desiccants or other drying agents to insure the devices dry out between water cycles,
D) Molding said chemicals into a semi rigid flexible or solid shape designed to fit over a pipe or drip tube and underneath an irrigation emitter
E. Adding an optional clip as an insert for the release device so that for more rigid release designs the clip is part of the inner circumference of the molded shape and provides spring tension to the pipe or tube to allow it to stay in place and be easily removed and replaced,
F. Placing the molded release device underneath the emitter and below the gravity level of the water release point of the said emitter so that the device does not interfere with the irrigation system water or create a back flow path into the water supply system when the water valve is shut off, but provides a path for water to flow over it releasing the water soluble elements within it while flowing downward to the planted areas underneath and around,
G. Establishing water pressure internal to the irrigation system and at regular intervals opening the valve to said irrigation system so that water is allowed to flow out of the system's irrigation emitters and over the releasing devices below it,
H) Shutting off the water irrigation valve after a watering cycle interval and allowing the irrigation releasing device to dry out for at given time before the next irrigation cycle,

2. An device for dispensing chemicals attached to an drip or bubbler irrigation system emitter comprising a molded flexible, semi rigid or rigid device containing desired chemicals to be released by water flow from the irrigation system emitter and attached underneath emitter, containing fertilizers, pesticides, insecticides or other chemical agents that are combined with a slow releasing water soluble medium which is molded into specific shapes designed to fit over an irrigation pipe or drip tube under an irrigation emitter or in confluence with it, with or without an integral insertion clip as part of the molded design, capable of being easily installed and replaced and identified by use of color additives in the mixture, which indicate the type of release device, the specific formula it contains and the release rate or life cycle it has, able to stay in place over the life of the device and dry out after each watering cycle to preserve its chemical content and viability for the next watering cycle, cost effective, able to work with a multitude of irrigation systems and emitters, having the ability to easily vary the chemical formulas for various plant mediums, soils, climates and growing seasons.

3. An apparatus according to claim 2 further comprising a multitude of stacked molded devices under an irrigation system emitter that provides slow release of a combinations of chemicals such as fertilizers, pesticides, herbicides and other desired chemical formulas simultaneously or one molded device containing a combination of chemicals combined into one device and providing multiple chemical releases said device.
